(19) United States
(12) Patent Application Publication
(10) Pub. No.: US 2008/0145637 A1
(43) Pub. Date: Jun. 19, 2008

(54) Color Stabilized Composite Material

(76) Inventor: Thomas P. Frank, Wausau, WI (US)

Correspondence Address: QUARLES & BRADY LLP, 411 E. WISCONSIN AVENUE, SUITE 2040, MILWAUKEE, WI, 53202-4497, US

(21) Appl. No.: 11/666,467

(22) PCT Filed: Oct. 26, 2005
(86) PCT No.: PCT/US05/38456

§ 371 Date: Apr. 26, 2007

Related U.S. Application Data
(60) Provisional application No. 60/622,491, filed on Oct. 27, 2004.

(51) Int. Cl. B32B 21/00; C08L 97/02; C08K 9/00

(52) U.S. Cl. 428/292.4; 524/9; 524/13; 524/15; 524/10; 523/200

(57) ABSTRACT

A color stabilized composite material combines polymers with cellulosic natural fibers or wood or wood based composite materials to manufacture an array of products for both indoor and outdoor applications. The invention provides the means to enhance the color stability of such products from the negative effects of ultraviolet radiation and weather in addition to improving the physical properties of the overall fiber-polymer matrix. In one aspect, the invention provides a composite material including a natural fiber, such as wood flour, and a polymer resin, wherein the natural fiber has been pretreated with a bleaching or oxidizing agent. In another aspect, the invention provides a color stabilized composite building material including an elongated substrate, and a thermoplastic material coating disposed on a longitudinal circumference of the substrate, which may be wood or a wood-based composite material such as plywood, cellulosic fiberboard, particle board, waferboard, flakeboard, chipboard, or oriented strand board.

### CROSS-REFERENCES TO RELATED APPLICATIONS

This application claims priority from U.S. Provisional Patent Application No. 60/622,491 filed Oct. 27, 2004.

### STATEMENT REGARDING FEDERALLY SPONSORED RESEARCH

Not Applicable.

### BACKGROUND OF THE INVENTION

1. Field of the Invention

This invention relates to composite materials used to fabricate such products as decking boards, railings, marine docks, siding, fencing, panels, roof tiles, trim & moldings, and other support or decorative items. Specifically, this invention relates to the color stability and physical performance improvement of said products that use composite materials which are exposed to the negative effects of ultraviolet radiation, weather, and other harmful environmental effects.

2. Description of the Related Art

Composite materials including a wood-based product and a polymeric material are known in the art. See, for example, U.S. Pat. Nos. 3,943,079, 4,285,997, 4,687,793, 4,866,110, 5,120,776, 5,538,547, 5,593,483, 5,973,035, 6,120,556, 6,164,034, 6,172,144, 6,383,652, 6,627,676, and U.S. Patent Application Nos. 2002/0010229, 2003/0032702 and 2003/0187102, and Japanese Patent Application Nos. 58-204050, 59-133255, 60-73807, and 9-157471.

It is well known that natural fiber composite materials used to manufacture various indoor and outdoor products deteriorate over time. Very often, the manufacturers of products that use natural fiber composite materials will describe the visual deterioration of their products in their literature as a natural weathering effect or a gradual graying of the material over time. Quite often, depending on location, a significant shift in the color-appearance of the product's color occurs in just one year.

Manufacturers of natural fiber composite material type products typically blend various amounts of natural fiber, like wood, with thermoplastic polymers. The most common thermoplastic polymers used are polyethylene, polypropylene and polyvinyl chloride; although any polymer with suitable performance characteristics may be used. The amount of fiber mixed with the polymer can vary widely from 1-2% by weight, to 60-80% by weight or more. However, most high-volume applications today, for deck boards as an example, are produced at about a ratio of 50:50 fiber/polymer matrix plus other additives.

Historically fiber, and more specifically wood flour, has been used in natural fiber composites because of its favorable effects on the overall physical performance of the end-product, including a significant reduction in the overall material cost per pound when compared to the polymer price alone. However natural fiber, including wood flour, is very susceptible to the negative effects of ultraviolet light and weather as described in this invention. Natural fiber, including wood flour, is also susceptible to other problems too. Mold and mildew growth impinges upon the surface appearance of fiber-polymer products. It also can significantly degrade the physical performance parameters of the product over time. Fiber staining due to surface dirt, grease etc. also diminishes the overall appearance of the product.

Additionally, moisture absorption of the fiber when exposed to multiple freeze-thaw cycles can degrade the product. Limiting or eliminating the moisture absorption of natural fiber-polymer materials is usually preferred.

Furthermore, wood flour and other natural fibers have various amounts of lignin and other chemical constituents that yellow and discolor under higher temperatures. Effectively removing or altering these compounds allows the material to be able to withstand higher processing temperatures and the fiber-polymer matrix to withstand higher application temperatures.

Being able to process fiber at a higher processing temperature is very useful when one wishes to create a fiber-polymer material using polymers that require higher processing temperatures than polyethylene, polypropylene, etc. For example, nylons typically process at higher temperatures that common wood flour can withstand today thereby limiting their usefulness.

To date, the natural fiber composite material producers or the manufacturers of products that use natural fiber composite materials have attempted to minimize the negative effects of ultraviolet radiation and weather by adding UV inhibitors, UV blockers, bonding agents, colorants and various other additives to the composite material matrix to minimize or mask the problem of color stability as well as other problems. The color stability problem, frequently described by the industry as a “natural weathering” or “gradual graying” of the product is done so as to alert the consumer about the stark difference of these products when compared to more color stable (colorfast) products like vinyl siding, etc. Furthermore, while the current state-of-the-art has helped to partially reduce these negative product attributes, the industry agrees that the performance of these types of products are still inadequate despite the significant increase in the product's cost required to marginally improve upon the current state-of-the-art.

This invention solves a very large problem that has plagued the natural fiber-composites market now for over 10 years. Currently, almost 1 million tons of material is processed each year just for composite decking. The composite decking industry is predominantly a wood-polymer market with approximately 15% market share this last year. Just 5 years ago the market share was less than 5%. The projected growth rate is within a range of 20-30% per year for the next 5 years.

However, in spite of the large amount of money this market presents, and the fact that numerous very large entities are developing products for this market and seeking product improvements on a daily basis, a color stability problem persists along with other types of problems that represent large market opportunities if resolved.

There is very strong interest in an economical solution to this problem of color stability. There is also strong interest in problems associated with mold and mildew growth, and fiber staining as well. Likewise, an improvement in physical strength characteristics is also desired.

Beyond color stability, the interrelationship of problems like mold & mildew, fiber staining, and physical strength & performance have a common denominator that lies in the integrity of the bond between the fiber and the polymer. Suffice it to say that if the integrity of the bond between the fiber and the polymer matrix is enhanced then;

1) The stress from the fiber-polymer matrix can be transferred to the fiber thus improving certain strength characteristics.
a) Improving the strength of the fiber-polymer bond can be helpful in achieving a flexural modulus high enough to achieve certification as a load-bearing member in many construction environments.
   i) It is well understood that a minimum value of about 1.0 M-psi to 1.2 M-psi is necessary for these types of applications.
b) Improving the strength of the fiber-polymer bond can be helpful in achieving higher heat deflection temperatures.
   i) A higher heat deflection temperature rating expands the practical usefulness of the fiber-polymer matrix in environments where higher temperatures and material loads are of concern.

2) An increased bond between the fiber and polymer acts to shield the fiber, a microbial nutrient source, from various molds and mildews thus acting as a barrier or inhibitor to enhanced microbial growth.

3) An increased bond between the fiber and polymer acts to shield the fiber from additional moisture uptake thus serving to minimize the amount of moisture held within the fiber of a fiber-polymer product.
a) Reduced fiber moisture levels are preferred as a means to minimize the negative effects that a freeze-thaw cycle has upon the product.
b) Repetitive expansion and contraction of the material reduces the useful life of the product or restricts the use of the product from certain applications.

4) Likewise, an enhanced bond between the fiber and the polymer shields the fiber from rain, cooking greases, etc. all of which act in a manner as to discolor the fiber through means which are not the same as those addressed as color stability or colorfast issues.

5) Altering the chemical constituency of the fiber also acts in a way that is beneficial in reducing the negative effects of lignin and other complex compounds found within fiber.
a) Effectively removing these compounds from the fiber-polymer matrix allows the material to be able to withstand higher processing and application temperatures.
   i) One such compound is tannin. Tannin, when combined with iron forms iron-tannate, an unsightly ink-like substance that is very difficult to remove or mask.

The basic color stability problem begins when a consumer buys a composite decking product in the color of their choice (they come pre-colored in oak-cedar-redwood etc.) and it is installed, they would prefer that the color remain the same. A good analogy is PVC siding for your home. If you choose brown, you want it to stay brown. And for the most part this occurs with non-fiber filled polymeric PVC siding, with its associated additives. Although you will note that over several years of time, the color does lighten or gray on PVC siding as well; especially on the portions of your home that faces the south (sunlight).

With composite decking (like Trex®) the current state-of-the art is at a level where your pre-colored decking experiences a significant graying from its original “purchased color”, quite often within just 1 year. Furthermore, if you had placed a flower pot, grill or other item on your deck at the beginning of summer, you will note the significant difference in the color underneath these items as you move them after the end of just one summer season. This color contrast is completely unacceptable for the normal consumer, as is the overall graying of the composite deck's color, from its original “purchased color”, in such a short period of time.

Unlike non-fiber filled polymeric PVC siding, composite decking has a large percentage of wood in its material composition. And unlike PVC and other polymers (HDPE or PP) used in the decking industry, wood and other natural fibers are affected by weather and ultraviolet radiation much faster than a pure UV stabilized (additives) polymer. How quickly will wood fade? This is best described by another simple analogy, mulch. How quickly does mulch fade from the affects of weather in just one summer? And if you have ever observed someone who uses the colored mulches seen in recent years, you will note how much of the color is no longer there after just one summer.

The type of wood used today for wood-polymer deck boards is commonly referred to as wood flour. The material supply stream for the wood-polymer industry originates as wood waste from post-industrial scrap sources such as window and door manufacturers, flooring and cabinet producers etc. This material is clearly kiln dried wood or green, wet wood waste that has been dried. However it is very important to not limit this invention to just this wood waste stream, the process will work equally as well on wood processed directly from a fallen tree, or other wet fiber or cellulosic sources. None of these fibers have had the lignin, and other complex compounds within wood fiber removed. It is the lignin and perhaps the other complex fiber compounds as well, that contributes to the color stability (fading) problem.

Regardless of the fiber source, the fiber is milled or reduced to a suitable size, usually 20-100 mesh. Ground wood fiber in the range of 10 mesh and smaller (the higher the mesh number, the smaller the size) is commonly called wood flour. Wood flour is the material used in most of the wood-polymer decking boards made today (from wood). Other natural fiber wood substitutes are used as well such as peanut shells, rice hulls, flax, kenaf, feathers etc., although the suitability of all of these fibers has not been thoroughly examined. Wood has about 95% of the natural fiber market share for composite decking etc. The invention will work for other natural fibers as well as wood. Wood flour sells for anywhere from $0.03-$0.10 per pound or $60-$200 per ton. Most merchant wood flour is within the price range of $100-$140 per ton in what can be described as a fiercely competitive market.

Thus, there is a need for composite building materials having improved color stability and physical performance when the materials are exposed to ultraviolet radiation, weather, and other harmful environmental effects. Also, there is a need for methods for making these improved color stabilized composite building materials.

### SUMMARY OF THE INVENTION

The foregoing needs are met by a color stabilized composite material according to the invention that combines polymers with cellulosic natural fibers or wood or wood based composite materials to manufacture an array of products for both indoor and outdoor applications. The invention provides the means to enhance the color stability of such products from the negative effects of ultraviolet radiation and weather in addition to improving the physical properties of the overall fiber-polymer matrix. In one aspect, the invention provides a composite material including a natural fiber, such as wood flour, and a polymer resin, wherein the natural fiber has been pretreated with a bleaching or oxidizing agent. In another aspect, the invention provides a color stabilized composite building material including an elongated substrate, and a thermoplastic material coating disposed on a longitudinal circumference of the substrate, which may be wood or a wood-based composite material such as plywood, cellulosic fiberboard, particle board, waferboard, flakeboard, chipboard, or oriented strand board.

In one aspect, the present invention allows anyone to use ordinary wood flour, or any other natural fiber, and to modify the material so that it significantly slows or eliminates the graying process described above as a color stability or colorfast problem. A nominal amount of reduction from the problem as it exists today is adequate to address current market concerns. However, the level of reduction is selectable and can be enhanced by altering formulations within a broad but very relevant range. The variable material cost to accomplish this is generally within a range of $0.04-$0.10 per pound ($80-$200 per ton) depending on the degree of color-fade reduction one would desire. It is likely that in the future, higher loadings may be desired than what is generally accepted today to achieve acceptable colorfast performance. This paves the way for several different models of fade-resistant deck boards not unlike the selection of cars and various models and options that exist today.

While the negative effects of ultraviolet radiation and weather had been well known to the wood and plastics industry for over well 50 years, an economical solution that overcomes the problem as described above has not heretofore been obvious to anyone within the industry. Furthermore, despite the significant consumer demand for a more color-stable product with greater weather resistance, a suitable product is not available.

This invention has additional benefits beyond what is stated thus far. Some fibers are unacceptably high in tannin. Tannin, when placed in contact with iron will form iron tannate, an ink-like stain that is very unsightly and difficult to remove. In applications where appearance is critical, fibers unacceptably high in tannin are not preferred, thus eliminating a source of fiber that may be more economical than other fiber sources depending on your geographical location or the overall availability of fiber.

Extracting tannins from oak wood flour or fiber, as well extracting other harmful compounds or constituents found in natural fiber is readily accomplished through the use of this invention.

To summarize, providing a product that is color stable or colorfast is an important feature to customers who purchase natural fiber-polymer based products. This invention addresses this market demand.

In addition to the positive features of color stability, this invention promotes and significantly improves upon the following features by: A) extracting or modifying harmful chemistries from wood or various other fibers, and B) altering the ability of wood and other natural fiber to create a stronger bond to various polymers.

The use of this invention transforms the current state-of-the art for using wood flour and other natural fibers from a status of cost reducing filler to the status of a performance enhancing additive. Those skilled in the art will quickly recognize the benefits as;

1) Improved strength.
a) Flexural strength.
   i) Load bearing construction-like applications.
b) Tensile strength.
c) Impact strength.
d) Heat deflections temperatures.

2) Improved microbial resistance.
a) Visual enhancements.
   i) Molds.
   ii) Mildews.
   iii) Other microbials.
b) Reduction in long-term physical performance degradations due to.
   i) Molds.
   ii) Mildews.
   iii) And other microbials.

3) Increased moisture uptake resistance.
a) Decreased freeze/thaw effects.
b) Reduced expansion/contractions due to moisture.

4) Enhanced sealing of the fiber.
a) More dirt and grease resistant.

5) Reduction of harmful fiber constituents.
a) Lignin and other complex fiber chemistries and their associated discoloration due to weather.
b) Lignin and other complex fiber chemistries and their associated higher temperature limitations.
c) Tannin and the formation of iron tannate stains.

In another aspect, the present invention provides for materials, such as UV inhibitors, UV blockers, colorants, decals. powder coatings, decorative inserts or inlays, co-extrusion or post-extrusion coatings, multilayer extrusions, to be placed, adhered to, sprayed, extruded, or vapor deposited on the surface of any wood or wood-based composite part at such a thickness that the materials act to protect the wood or wood-based composite part from the effects of weathering, color fading, mold and mildew growth, etc. The materials may then be covered with a clear coat of material (such as clear polymers) to help protect the materials from scratching or wearing off due to foot traffic or abrasion against the materials. When incorporated as a co-extrusion or multi-layer extrusion, the process can provide for a relatively thin protective layer and the matrix can include the materials and the protective material in one composite matrix.

These and other features, aspects, and advantages of the present invention will become better understood upon consideration of the following detailed description, drawings, and appended claims.

### BRIEF DESCRIPTION OF THE DRAWINGS

FIG. 1 is a perspective view of a color stabilized composite building material according to the invention.

FIG. 2 is a cross-sectional view of the material of FIG. 1 taken along line 2-2 of FIG. 1.

### DETAILED DESCRIPTION OF THE INVENTION

This invention provides a natural fiber material that exhibits significant reductions in the color shift of natural fiber composite products caused by the fiber reacting to the negative effects of ultraviolet radiation and weather. This is accomplished by accelerating the negative effects that ultraviolet radiation and weather has upon the visual appearance of the fiber thus minimizing any post-production color shifts that would normally occur.

Additionally, this invention addresses and resolves the problems associated with the poor affinity of polymers with the various natural fibers available today thereby resulting in weak or nonexistent (mechanical encapsulation) bonds between the polymer and the fiber.

The natural fiber can exist in many different physical embodiments from large particles of fiber, such as hog, shavings, sawdust, or saw kerfs of wood, to finely ground particles of wood, commonly called wood flour with sizes of 10 mesh (2000 microns) down to 200 mesh (75 microns) or smaller. The preferred method being to size the fiber material as desired prior to treating the fiber as described in this invention.

Once the fiber is sized properly and treated, as described in this invention, then the fiber can be immediately mixed with polymer and other additives and further processed to form finished products such as in a direct extrusion process, or the fiber can be pelletized or formed into a suitable fiber-polymer matrix to be used a later time.

In addition to allowing for various forms and sizes of fiber to be treated, this invention also allows for varying degrees of treatment effectiveness based upon time, temperature, and the concentrations of the various ingredients used to treat the fiber. The basic formulation can be modified for various types of fibers or fiber sizes. And as is the case of wood, for various species of wood such as maple and pine, as well as for the level of the color stability desired or some other preferred physical enhancement of the final fiber-polymer matrix.

The invention provides a composite material comprising of 5%-90% natural fiber and 10%-95% of polymer whereby the fiber's appearance simulates the natural affects of weathering or aging. The natural fiber material used may be wood, hemp, flax, kenaf, peanut shells, feathers, or mixtures thereof. In one form, the natural fiber material used is any type of cellulosic material. However, the natural fiber may be replaced by man made filler or reinforcement material. The natural fiber may be sized by conventional means to a predetermined value. The polymer is any binder material suitable for encapsulating the natural fiber. The polymer may be a thermoplastic material such as a polyolefin (e.g., polypropylene or polyethylene). However, the polymer may be another type of thermoplastic or the polymer may be a thermoset material. The polymer may also be a natural polymer.

In one embodiment, the invention provides a composite material comprising of 5%-90% natural fiber and 10%-95% of polymer wherein the natural fiber has been treated chemically prior to mixing with the polymer. The fiber may be treated to simulate the natural affects of weathering or aging. The process for treating the fiber may be accomplished in either a continuous or a batch process. The surface of the natural fiber material may be altered to promote bonding of the fiber to the polymer. For example, the method of exposing the fiber to various treatments alters the fiber surface chemistry thereby facilitating a larger degree of encapsulation and physical bonding of the natural fiber to the polymer matrix.

In another embodiment, the invention provides a composite material comprising of 5%-90% natural fiber and 10%-95% of polymer wherein the natural fiber has been treated with wet chemicals. Preferably, the fiber treatment has no by-products.

In yet another embodiment, the invention provides a pre-faded or color-shifted natural fiber for use in natural fiber composite materials or products that use natural fiber composite materials, where the negative effects of ultraviolet radiation and weather have been minimized or eliminated. The natural fiber material used is wood sometimes referred to as wood flour, sawdust, or wood fiber. Alternatively, the natural fiber material used is hemp, flax, kenaf, peanut shells, feathers or mixtures thereof. Optionally, the natural fiber material used is other natural fiber materials.

In still another embodiment, the invention provides a method of pre-fading natural fiber by exposing the fiber to various oxidizing or bleaching agents that alter the fibers surface chemistry, thereby having an effect of lightening the color of the fiber and therefore accelerating the negative effects of ultraviolet radiation or weather thus minimizing the post-production color shifts of the natural fiber composite material product due to ultraviolet radiation and weather. This method of exposing the fiber to various oxidizing or bleaching agents that alter the fibers surface chemistry also facilitates a larger degree of encapsulation and physical bonding of the pre-faded fiber to the polymer matrix.

In yet another embodiment, the invention provides a composite material comprising of 5%-90% natural fiber and 10%-95% of polymer whereby the fiber is pre-treated and then further processed into a suitable form. The fiber may be pre-treated and then immediately processed, along with the polymer and other additives, using ordinary plastic processing techniques such as injection molding or extrusion. Alternatively, the fiber is pre-treated and then immediately processed into a shape of a natural fiber-polymer pellet to be stored or shipped for processing at a later date or time. Alternatively, the fiber is pre-treated and then shipped or stored without adding any polymer.

In still another embodiment, the invention provides a method of pre-fading natural fiber by exposing the fiber to various oxidizing or bleaching agents that alter the fibers surface chemistry, thereby having an effect of lightening the color of the fiber and therefore accelerating the negative effects of ultraviolet radiation or weather upon the visual appearance of the product which then minimizes the post-production color shifts of the natural fiber composite material product due to ultraviolet radiation and weather and where the materials used do not create any residual by-products that must be disposed of or placed into a landfill.

In yet another embodiment, the invention provides a method of pre-fading natural fiber by exposing the fiber to various oxidizing or bleaching agents that alter the fibers surface chemistry, thereby having an effect of lightening the color of the fiber and therefore accelerating the negative effects of ultraviolet radiation or weather upon the visual appearance of the product which then minimizes the post-production color shifts of the natural fiber composite material product due to ultraviolet radiation and weather.

In still another embodiment, the invention provides a composite material comprising of 5%-90% natural fiber and 10%-95% of polymer whereby the natural fiber has been modified to enhance a bond between the fiber and polymer to increase the strength of materials for flexural values, for tensile strength, for impact strength, or for heat deflection temperatures.

In yet another embodiment, the invention provides a composite material comprising of 5%-90% natural fiber and 10%-95% of polymer whereby the natural fiber has been modified to enhance a bond between the fiber and polymer to inhibit microbial activity, and thereby enhance visual appearance or improve the long-term mechanical performance of the material.

In still another embodiment, the invention provides a composite material comprising of 5%-90% natural fiber and 10%-95% of polymer whereby the natural fiber has been modified to enhance a bond between the fiber and polymer thereby reducing fiber moisture absorption.

In yet another embodiment, the invention provides a composite material comprising of 5%-90% natural fiber and 10%-95% of polymer whereby the natural fiber has been modified to enhance a bond between the fiber and polymer thereby reducing freeze/thaw degradation of the material.

In still another embodiment, the invention provides a composite material comprising of 5%-90% natural fiber and 10%-95% of polymer whereby the natural fiber has been modified to enhance a bond between the fiber and polymer thereby reducing material expansion and contractions due to the presence of moisture.

In yet another embodiment, the invention provides a composite material comprising of 5%-90% natural fiber and 10%-95% of polymer whereby the natural fiber has been modified to enhance a bond between the fiber and polymer thereby reducing staining due to grease and dirt.

In still another embodiment, the invention provides a composite material comprising of 5%-90% natural fiber and 10%-95% of polymer wherein the natural fiber has been treated chemically to remove or alter complex fiber chemistries, such as lignin or tannin, to improve high temperature withstands and/or eliminate iron tannate staining.

In yet another embodiment, the invention provides a method of making a composite material. In the method, a natural fiber is combined with a synthetic polymer resin, wherein the natural fiber has been pretreated with a bleaching or oxidizing agent. The bleaching or oxidizing agent may be selected from the group consisting of hydrogen peroxide, inorganic peroxides, organic peroxides, inorganic persalts, and mixtures thereof, or the bleaching or oxidizing agent may selected from hydrogen peroxide, alkali metal perborates, alkali metal percarbonates, alkali metal persulfates, and mixtures thereof. The natural fiber is preferably wood flour, and the resin may be selected from polyethylene, polypropylene and polyvinyl chloride.

In still another embodiment, the invention provides a composite material comprising a natural fiber and a synthetic polymer resin, wherein the natural fiber has been pretreated with a bleaching or oxidizing agent. The bleaching or oxidizing agent may be selected from the group consisting of hydrogen peroxide, inorganic peroxides, organic peroxides, inorganic persalts, and mixtures thereof, or the bleaching or oxidizing agent may selected from hydrogen peroxide, alkali metal perborates, alkali metal percarbonates, alkali metal persulfates, and mixtures thereof. The natural fiber is preferably wood flour, and the resin may be selected from polyethylene, polypropylene and polyvinyl chloride.

In yet another embodiment, the invention provides a filler for a composite material including a synthetic polymer resin, wherein the filler comprises a natural fiber that has been treated with a bleaching or oxidizing agent. The bleaching or oxidizing agent may be selected from the group consisting of hydrogen peroxide, inorganic peroxides, organic peroxides, inorganic persalts, and mixtures thereof, or the bleaching or oxidizing agent may selected from hydrogen peroxide, alkali metal perborates, alkali metal percarbonates, alkali metal persulfates, and mixtures thereof. The natural fiber is preferably wood flour, and the resin may be selected from polyethylene, polypropylene and polyvinyl chloride.

In yet another embodiment, the invention provides a method for making a filler for a composite material including a synthetic polymer resin. In the method, a natural fiber is contacted with a bleaching or oxidizing agent and the fiber is separated from the bleaching or oxidizing agent to form a filler. The bleaching or oxidizing agent may selected from the group consisting of hydrogen peroxide, inorganic peroxides, organic peroxides, inorganic persalts, and mixtures thereof, or the bleaching or oxidizing agent may be selected from hydrogen peroxide, alkali metal perborates, alkali metal percarbonates, alkali metal persulfates, and mixtures thereof. In one form, the natural fiber is wood flour and the resin is selected from polyethylene, polypropylene and polyvinyl chloride.

In still another embodiment, the invention provides a method of making a composite material, the method involves (i) contacting a natural fiber with a bleaching or oxidizing agent and separating the fiber from the bleaching or oxidizing agent to form a filler; and (ii) combining the filler with a synthetic polymer resin. The bleaching or oxidizing agent may be selected from the group consisting of hydrogen peroxide, inorganic peroxides, organic peroxides, inorganic persalts, and mixtures thereof, or the bleaching or oxidizing agent may be selected from hydrogen peroxide, alkali metal perborates, alkali metal percarbonates, alkali metal persulfates, and mixtures thereof. In one form, the natural fiber is wood flour. The step of combining the filler with the synthetic polymer resin may involve mixing the polymer resin with the filler and forming the composite material by extruding the resin and filler mixture, or the step of combining the filler with the synthetic polymer resin may involve mixing the polymer resin with the filler, pelletizing the resin and filler mixture, and forming the composite material by extruding the pelletized resin and filler mixture. Preferably, the resin is selected from polyethylene, polypropylene and polyvinyl chloride.

In yet another embodiment, the invention provides an extrudable pellet comprising a natural fiber and a synthetic polymer resin, wherein the natural fiber has been pretreated with a bleaching or oxidizing agent. The bleaching or oxidizing agent may be selected from the group consisting of hydrogen peroxide, inorganic peroxides, organic peroxides, inorganic persalts, and mixtures thereof, or the bleaching or oxidizing agent may be selected from hydrogen peroxide, alkali metal perborates, alkali metal percarbonates, alkali metal persulfates, and mixtures thereof. Preferably, the natural fiber is wood flour, and the resin is selected from polyethylene, polypropylene and polyvinyl chloride.

In still another embodiment, the invention provides a method of making a composite material from a mixture including a synthetic polymer resin where the method comprises substituting natural fibers that have been pretreated with a bleaching or oxidizing agent for chemically untreated natural fibers in the mixture. The bleaching or oxidizing agent may be selected from the group consisting of hydrogen peroxide, inorganic peroxides, organic peroxides, inorganic persalts, and mixtures thereof, or the bleaching or oxidizing agent may be selected from hydrogen peroxide, alkali metal perborates, alkali metal percarbonates, alkali metal persulfates, and mixtures thereof. Preferably, the natural fiber is wood flour. The step of combining the filler with the synthetic polymer resin may involve mixing the polymer resin with the filler and forming the composite material by extruding the resin and filler mixture.

In yet another embodiment, the invention provides a method for making a color stabilized composite material. In the method, a natural fiber is mixed with a first bleaching or oxidizing agent to provide once treated natural fiber which is then mixed with a second bleaching or oxidizing agent to provide twice treated natural fiber, which is added to a thermoplastic material to create a natural fiber-thermoplastic material mixture which is formed into a composite material. The mixture may be dried before forming the mixture, and preferably, the composite material is formed by extruding the mixture.

The natural fiber may be selected from the group consisting of wood, hemp, flax, kenaf, peanut shells, and feathers, and the thermoplastic material may be selected from the group consisting of polyethylene, polypropylene and polyvinyl chloride. Preferably, the natural fiber is wood flour.

The first bleaching or oxidizing agent and the second bleaching or oxidizing agent may be selected from the group consisting of hydrogen peroxide, inorganic peroxides, organic peroxides, inorganic persalts, and mixtures thereof. Preferably, the first bleaching or oxidizing agent is selected from the group consisting of hydrogen peroxide, alkali metal perborates, alkali metal percarbonates, alkali metal persulfates, and mixtures thereof, and the second bleaching or oxidizing agent is selected from the group consisting of hydrogen peroxide, alkali metal perborates, alkali metal percarbonates, alkali metal persulfates, and mixtures thereof. In one version of the method, the first bleaching or oxidizing agent is selected from the group consisting of alkali metal perborates and alkali metal percarbonates, and the second bleaching or oxidizing agent is selected from the group consisting of alkali metal perborates and alkali metal percarbonates. In another version of the method, the first bleaching or oxidizing agent is selected from the group consisting of alkali metal perborates and alkali metal percarbonates, and the second bleaching or oxidizing agent is selected from the group consisting of hydrogen peroxide, inorganic peroxides, and organic peroxides.

In still another embodiment, the invention provides a method for making a color stabilized composite material. In the method, natural fiber is mixed with a surfactant to provide once treated natural fiber which is then mixed with a second bleaching or oxidizing agent to provide twice treated natural fiber. The twice treated natural fiber is added to a thermoplastic material to create a natural fiber-thermoplastic material mixture, and the mixture is formed into a composite material. The mixture may be dried before forming the mixture, and preferably, the composite material is formed by extruding the mixture.

The natural fiber may be selected from the group consisting of wood, hemp, flax, kenaf, peanut shells, and feathers, and the thermoplastic material may be selected from the group consisting of polyethylene, polypropylene and polyvinyl chloride. Preferably, the natural fiber is wood flour.

The surfactant may be selected from soaps and mixtures thereof, and the second bleaching or oxidizing agent may be selected from the group consisting of hydrogen peroxide, inorganic peroxides, organic peroxides, inorganic persalts, and mixtures thereof. In one version of the method, the surfactant is selected from soaps and mixtures thereof, and the second bleaching or oxidizing agent is selected from the group consisting of hydrogen peroxide, alkali metal perborates, alkali metal percarbonates, alkali metal persulfates, and mixtures thereof. In another version of the method, the surfactant is selected from soaps and mixtures thereof, and the second bleaching or oxidizing agent is selected from the group consisting of alkali metal perborates and alkali metal percarbonates. In yet another version of the method, the surfactant is selected from soaps and mixtures thereof, and the second bleaching or oxidizing agent is selected from the group consisting of hydrogen peroxide, inorganic peroxides, and organic peroxides.

In yet another embodiment, the invention provides a method for making a color stabilized composite material. In the method, a natural fiber is coated with an ultraviolet inhibitor or an ultraviolet blocker to provide a coated natural fiber. Then the coated natural fiber is added to a thermoplastic material to create a coated natural fiber-thermoplastic material mixture, and the mixture is formed into a color stabilized composite material. The natural fiber may be selected from the group consisting of wood, hemp, flax, kenaf, peanut shells, and feathers, the thermoplastic material may be selected from the group consisting of polyethylene, polypropylene and polyvinyl chloride. In one form, the natural fiber is wood flour. Non-limiting examples of ultraviolet inhibitors and/or ultraviolet blockers include benzophenones, benzotriazoles, substituted acrylonitriles, phenol-nickel complexes, and titanium dioxide.

In one version of the method, the step of coating the natural fiber comprises mixing the natural fiber with a liquid including the ultraviolet inhibitor or the ultraviolet blocker. In another version of the method, the step of coating the natural fiber comprises mixing the natural fiber with an emulsion including the ultraviolet inhibitor or the ultraviolet blocker. In yet another version of the method, the step of coating the natural fiber comprises mixing the natural fiber with a powder including the ultraviolet inhibitor or the ultraviolet blocker. The natural fiber may be treated with a bleaching or oxidizing agent before coating the natural fiber with an ultraviolet inhibitor or an ultraviolet blocker. The bleaching or oxidizing agent may be selected from the group consisting of hydrogen peroxide, inorganic peroxides, organic peroxides, inorganic persalts, and mixtures thereof.

The method may further include drying the coated natural fiber before adding the coated natural fiber to the thermoplastic material. Also, the coated natural fiber may be pelletized before adding the coated natural fiber to the thermoplastic material, or alternatively the coated natural fiber-thermoplastic material mixture may be pelletized before forming the coated natural fiber-thermoplastic material mixture into a composite material. The step of forming the mixture may involve extruding the mixture. Optionally, colorants may be added to the coated natural fiber-thermoplastic material mixture.

In prior methods, the process of adding UV inhibitors or UV blockers along with colorants has been practiced by adding these elements to the entire composite matrix mixture. However, by doing this, a large portion of the natural fiber remains uncoated and does not receive the full benefit of the use of these additives. To add more colorants or UV inhibitors would be more beneficial but is cost prohibitive heretofore. This method according to the invention allows just the fiber (treated or untreated with a bleaching or oxidizing agent) to be coated with various UV inhibitors or UV blockers before (or concurrently) it is mixed with the rest of the composite matrix (i.e., polymers, colorants lubricants, etc.). The method can be a dry process, or can be a wet process whereby the UV inhibitors or UV blockers are mixed to penetrate or adhere to the natural fiber. For example, the UV blockers, UV inhibitors and/or other equivalents are part of an emulsion that is used to adhere the material to the natural fiber. The natural fiber may then be dried or evaporated. Alternatively, UV inhibitors such as titanium dioxide may be used in powder form to coat the natural fiber as titanium dioxide powder will stick to fiber such as wood flour.

In still another embodiment, the invention provides a method for making a color stabilized composite material. In the method, a natural fiber is mixed with a bleaching or oxidizing agent to provide a natural fiber mixture, and the natural fiber mixture is added to a thermoplastic material to create a natural fiber-thermoplastic material mixture. The natural fiber-thermoplastic material mixture is then formed into a composite material. The natural fiber may be selected from the group consisting of wood, hemp, flax, kenaf, peanut shells, and feathers, and the thermoplastic material may be selected from the group consisting of polyethylene, polypropylene and polyvinyl chloride. Preferably, the natural fiber is wood flour.

The bleaching or oxidizing agent may be selected from the group consisting of hydrogen peroxide, inorganic peroxides, organic peroxides, inorganic persalts, and mixtures thereof. Preferably, the bleaching or oxidizing agent is selected from the group consisting of hydrogen peroxide, inorganic peroxides, organic peroxides, and mixtures thereof. In one version of the method, the step of forming the natural fiber-thermoplastic material mixture into the composite material involves extruding the natural fiber-thermoplastic material mixture. During extrusion, the bleaching or oxidizing agent reacts with the natural fiber. Thus, this embodiment of the method is realized by using a reactive extrusion method whereby the natural fiber is treated either prior to or concurrent with mixing additional materials or extruding the final product. This reactive extrusion is beneficial in that treatment of the natural fiber is often a heat catalyzed chemical reaction. For example, when wood flour and hydrogen peroxide are added to an extruder, the heat of extrusion increases peroxide activity.

In yet another embodiment, the invention provides a color stabilized composite building material including an elongated substrate and a coating disposed on a longitudinal circumference of the substrate. A longitudinal circumference is a circumference perpendicular to the longitudinal axis of the substrate. Preferably, the entire longitudinal circumference is coated, although less than the entire longitudinal circumference may be coated to minimize the cost. For example, the parts of the substrate not susceptible to water contact may not be coated. The coating comprises a thermoplastic material, and the coating has a thickness of 0.005″ or greater. Preferably, the coating has a thickness of 0.050″ or greater. The upper limit of thickness for the coating is largely determined by the economics of the process and the final physical properties desired. An upper limit of 0.5″ may exist for some applications. Preferably, the thermoplastic material is water insoluble (e.g., polyethylene, polypropylene and polyvinyl chloride) and is applied without the use of solvents.

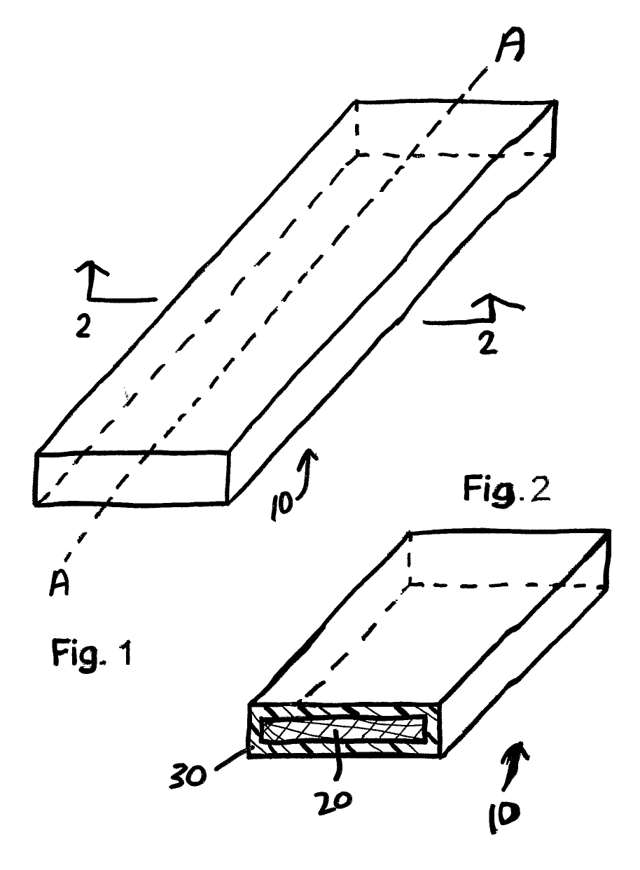

Referring to FIGS. 1 and 2, this embodiment of the invention is shown. The color stabilized composite building material 10 includes an elongated substrate 20 and a coating 30 disposed on a longitudinal circumference of the substrate 20. A longitudinal circumference is a circumference perpendicular to the longitudinal axis A of the substrate 20.

The substrate may consist essentially of wood, or the substrate may be a wood-based composite material selected from the group consisting of plywood, laminated veneer lumber, parallel-laminated veneer, cellulosic fiberboard, particle board, waferboard, flakeboard, chipboard, and oriented strand board. Examples of usable woods include, but are not limited to, pine, oak, maple, ash, poplar, and cedar. A wood-based composite material as described herein is typically made with a thermosetting or heat-curing resin or adhesive that holds the lignocellulosic (wood) fiber together. Commonly used resin-binder systems include phenol-formaldehyde, urea-formaldehyde, melamine-formaldehyde, and isocyanate.

In one version of the color stabilized composite building material, the coating includes an ultraviolet inhibitor or an ultraviolet blocker. The coating may also include a colorant. Optionally, the coating includes an inlay. The coating may be a powder coating such as an electrostatically applied coating. There may a clear protective layer over the coating. In one form, the protective layer includes a polymeric material. The coating may include an additive selected from the group consisting of antifungal agents, antimicrobial agents, fire retardant agents, pest control agents, and coupling agents.

Non-limiting examples of antifungal agents and antimicrobial agents include copper naphthenate, tetrachloroisophthalonitrile, chromated copper arsenate, ammoniacal copper quat, and copper azole mixtures. Non-limiting examples of fire retardant agents include mono-ammonium phosphate, di-ammonium phosphate, ortho-phosphoric acid, ammonium sulfate, borax/boric acid/boric oxide/disodium octoborate, and melamine phosphate. Non-limiting examples of pest control agents include creosote, chrome-copper-arsenate, organophosphates and boron compounds. Non-limiting examples of coupling agents include those agents which have been found to be effective in enhancing adhesion with cellulosic materials, for example, an ethylenically unsaturated carboxylic acid, substituted carboxylic acid or carboxylic acid anhydride.

Therefore, the invention provides means to produce a composite deckboard or other natural fiber composite product (railings siding, lineals, profiles, moldings, roofing shingles, etc,) by coating, extruding, co-extruding, or spraying onto the surface or portions of a wood or wood based product, materials in such a manner as to protect the natural fiber from the elements including the effects of weather, UV radiation, dirt, grime, etc. by using one of several thermoplastic polymers (such as polyvinyl chloride, polyethylene, polypropylene, a powder coating etc.) and various additives (UV inhibitors, UV blockers, colorants, etc.) in such a way that it serves to protect the natural wood or wood-based composite from the elements and/or eliminates the need to paint or stain the natural wood fiber (product) by coloring the coating/polymer thus eliminating the need to perform regular maintenance by re-staining or painting the natural wood product on a regular basis. The natural wood or wood-based composite may be treated (e.g., with preservatives, etc.) or untreated.

Thus, the invention also provides for materials, such as UV inhibitors, UV blockers, colorants, decals. powder coatings, decorative inserts or inlays, co-extrusion or post-extrusion coatings, multilayer extrusions, to be placed, adhered to, sprayed, extruded, or vapor deposited etc. on the surface of any wood or wood-based composite part at such a thickness that the materials act to protect the wood or wood-based composite part from the effects of weathering, color fading, mold and mildew growth, etc. The materials may then be covered with a clear coat of material (such as clear polymers) to help protect the materials from scratching or wearing off due to foot traffic or abrasion against the materials. When incorporated as a co-extrusion or multi-layer extrusion, the process can provide for a relatively thin protective layer and the matrix can include the materials and the protective material in one composite matrix.

In still another embodiment, the invention provides a color stabilized composite building material having a matrix including a polymeric material, and a delignified cellulosic fiber material dispersed in the matrix. The delignified cellulosic fiber material has a level of lignin such that the delignified cellulosic fiber material does not undergo a visually detectable color change when exposed to ultraviolet radiation, and the building material is essentially free of lignin. Color stability is best with a totally delignified fiber. Preferably, the polymeric material is a thermoplastic material, and most preferably, the thermoplastic material is selected from the group consisting of polyethylene, polypropylene and polyvinyl chloride. The fiber material may be selected from the group consisting of wood, hemp, flax, kenaf, and peanut shells, and preferably, the fiber material is wood flour. In one form, the building material comprises 10%-95% by weight of the polymeric material and 5%-90% by weight of the delignified cellulosic fiber material.

### EXAMPLES

The following Examples have been presented in order to further illustrate the invention and are not intended to limit the invention in any way.

### Example 1

a. Ingredients:
i. Sodium perborate tetrahydrate (5 grams).
ii. Sodium carbonate peroxyhydrate (5 grams).
iii. 40 mesh maple wood flour (25 grams).
iv. Water (100 grams)

b. The ingredients can be added at room temperature; however, higher temperatures will generally facilitate better results in less time.

c. Process step number 1.
i. Blend the sodium carbonate, wood flour and water together and mix well. Continue to mix for 10 to 15 minutes.

d. Process step number 2.
i. Add the sodium perborate tetrahydrate to the other ingredients from step one and continued to mix well for at least 5 minutes.

e. Upon the conclusion of the steps one in two, the material can be allowed to be:
i. Air dried.
ii. Accelerated drying by using heat and/or air circulation.
iii. Fed into the next stage of a proprietary plastic processing machine.

### Example 2

a. Ingredients:
i. Sodium carbonate peroxyhydrate (5 grams).
ii. Hydrogen peroxide, 35% (5 grams).
iii. 40 mesh maple wood flour (25 grams).
iv. Water (100 grams)

b. The ingredients can be added at room temperature; however, higher temperatures will generally facilitate better results in less time.

c. Process step number 1.
i. Blend the sodium carbonate, wood flour and water together and mix well. Continue to mix for 10 to 15 minutes.

d. Process step number 2.
i. Add the hydrogen peroxide to the other ingredients from step one and continued to mix well for at least 5-10 minutes.

e. Upon the conclusion of the steps one in two, the material can be allowed to be:
i. Air dried.
ii. Accelerated drying by using heat and/or air circulation.
iii. Fed into the next stage of a proprietary plastic processing machine.

### Example 3

a. Ingredients:
i. Sodium perborate tetrahydrate (5 grams).
ii. Sodium carbonate peroxyhydrate (5 grams).
iii. Hydrogen peroxide, 35% (10 grams).
iv. 40 mesh maple wood flour (25 grams).
v. Water (50 grams)

b. The ingredients can be added at room temperature; however, higher temperatures will generally facilitate better results in less time.

c. Process step number 1.
i. Blend the sodium perborate tetrahydrate, sodium carbonate, wood flour and water together and mix well. Continue to mix for 10 to 15 minutes.

d. Process step number 2.
i. Add the hydrogen peroxide to the other ingredients from step one and continued to mix well for at least 5-10 minutes.

e. Upon the conclusion of the steps one in two, the material can be allowed to be:
i. Air dried.
ii. Accelerated drying by using heat and/or air circulation.
iii. Fed into the next stage of a proprietary plastic processing machine.

### Example 4

a. Ingredients:
i. Hydrogen peroxide, 35% (10 grams).
ii. 40 mesh maple wood flour (25 grams).
iii. Warm water (45 grams)
iv. Soap or equivalent surfactant (5 grams)

b. The ingredients can be added at room temperature; however, higher temperatures will generally facilitate better results in less time.

c. Process step number 1.
i. Blend the warm water soap and wood flour together and mix well. Continue to mix for 10 to 15 minutes.

d. Process step number 2.
i. Add the hydrogen peroxide to the other ingredients from step one and continued to mix well for at least 5-10 minutes.

e. Upon the conclusion of the steps one in two, the material can be allowed to be:
i. Air dried.
ii. Accelerated drying by using heat and/or air circulation.
iii. Fed into the next stage of a proprietary plastic processing machine.

Due to the various types or species of natural fibers, the size of the fibers, the level of desired effect, ambient or operating temperature conditions, cost considerations, selected production equipment methods etc, it can be expected that the following concentrations and operating conditions will generally fall within the following range in Table 1.

TABLE 1

| | | | | | |
|---|---|---|---|---|---|
| | | | | | Soap or |
| Sodium | Sodium | | Water - | Fiber | Other |
| perborate | Carbonate | Hydrogen | Tap or | Wood | Surfactant/ |
| Tetrahydrate | Peroxyhydrate | Peroxide | Deionized | Flour | Cleaner |

Pre-Treatment

| | | | | | | |
|---|---|---|---|---|---|---|
| Typical | 0-40 | 0-40 | 0-40 | 5-400 | 100 | 0-20 |
| Range | | | | | | |
| Applied | 0-100 | 0-100 | 0-100 | 0-100 | 0-100 | 0-100 |
| Temperature | | | | | | |
| (° C.) | | | | | | |

Primary Treatment

| | | | | | | |
|---|---|---|---|---|---|---|
| Typical | 0-40 | 0-40 | 0-40 | 5-400 | 100 | 0-20 |
| Range | | | | | | |
| Applied | 0-100 | 0-100 | 0-100 | 0-100 | 0-100 | 0-100 |
| Temperature | | | | | | |
| (° C.) | | | | | | |

The process is well suited for batch or continuous processing. All levels are percent by weight of a typical fiber unless noted otherwise. Specific chemicals are for reference only. It is expected that many substitutes or equivalent combinations exist.

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A method for making a color stabilized composite material, the method comprising:
providing a natural fiber;
mixing the natural fiber with a first bleaching or oxidizing agent to provide once treated natural fiber;
mixing the once treated natural fiber with a second bleaching or oxidizing agent to provide twice treated natural fiber; and
adding the twice treated natural fiber to a thermoplastic material to create a natural fiber-thermoplastic material mixture; and
forming the mixture into a composite material.

2. The method of claim 1 wherein:
the natural fiber is selected from the group consisting of wood, hemp, flax, kenaf, peanut shells, and feathers.

3. The method of claim 1 wherein:
the thermoplastic material is selected from the group consisting of polyethylene, polypropylene and polyvinyl chloride.

4. The method of claim 1 wherein:
the first bleaching or oxidizing agent is selected from the group consisting of hydrogen peroxide, inorganic peroxides, organic peroxides, inorganic persalts, and mixtures thereof, and
the second bleaching or oxidizing agent is selected from the group consisting of hydrogen peroxide, inorganic peroxides, organic peroxides, inorganic persalts, and mixtures thereof.

5. The method of claim 1 wherein:
the first bleaching or oxidizing agent is selected from the group consisting of hydrogen peroxide, alkali metal perborates, alkali metal percarbonates, alkali metal persulfates, and mixtures thereof, and
the second bleaching or oxidizing agent is selected from the group consisting of hydrogen peroxide, alkali metal perborates, alkali metal percarbonates, alkali metal persulfates, and mixtures thereof.

6. The method of claim 1 wherein:
the first bleaching or oxidizing agent is selected from the group consisting of alkali metal perborates and alkali metal percarbonates, and
the second bleaching or oxidizing agent is selected from the group consisting of alkali metal perborates and alkali metal percarbonates.

7. The method of claim 1 wherein:
the first bleaching or oxidizing agent is selected from the group consisting of alkali metal perborates and alkali metal percarbonates, and
the second bleaching or oxidizing agent is selected from the group consisting of hydrogen peroxide, inorganic peroxides, and organic peroxides.

8. The method of claim 1 wherein the natural fiber is wood flour.

9. The method of claim 1 wherein the step of forming the mixture comprises extruding the mixture.

10. The method of claim 1 wherein method further comprises drying the mixture before the step of forming the mixture.

11. A method for making a color stabilized composite material, the method comprising:
providing a natural fiber;
mixing the natural fiber with a surfactant to provide once treated natural fiber;
mixing the once treated natural fiber with a second bleaching or oxidizing agent to provide twice treated natural fiber; and
adding the twice treated natural fiber to a thermoplastic material to create a natural fiber-thermoplastic material mixture; and
forming the mixture into a composite material.

12. The method of claim 11 wherein:
the natural fiber is selected from the group consisting of wood, hemp, flax, kenaf, peanut shells, and feathers.

13. The method of claim 11 wherein:
the thermoplastic material is selected from the group consisting of polyethylene, polypropylene and polyvinyl chloride.

14. The method of claim 11 wherein:
the surfactant is selected from soaps and mixtures thereof, and
the second bleaching or oxidizing agent is selected from the group consisting of hydrogen peroxide, inorganic peroxides, organic peroxides, inorganic persalts, and mixtures thereof.

15. The method of claim 11 wherein:
the surfactant is selected from soaps and mixtures thereof, and
the second bleaching or oxidizing agent is selected from the group consisting of hydrogen peroxide, alkali metal perborates, alkali metal percarbonates, alkali metal persulfates, and mixtures thereof.

16. The method of claim 11 wherein:
the surfactant is selected from soaps and mixtures thereof, and
the second bleaching or oxidizing agent is selected from the group consisting of alkali metal perborates and alkali metal percarbonates.

17. The method of claim 11 wherein:
the surfactant is selected from soaps and mixtures thereof, and
the second bleaching or oxidizing agent is selected from the group consisting of hydrogen peroxide, inorganic peroxides, and organic peroxides.

18. The method of claim 11 wherein the natural fiber is wood flour.

19. The method of claim 11 wherein the step of forming the mixture comprises extruding the mixture.

20. The method of claim 11 wherein method further comprises drying the mixture before the step of forming the mixture.

21. A method for making a color stabilized composite material, the method comprising:
providing a natural fiber;
coating the natural fiber with an ultraviolet inhibitor or an ultraviolet blocker to provide a coated natural fiber; and
thereafter adding the coated natural fiber to a thermoplastic material to create a coated natural fiber-thermoplastic material mixture; and
forming the mixture into a color stabilized composite material.

22. The method of claim 21 wherein:
the natural fiber is selected from the group consisting of wood, hemp, flax, kenaf, peanut shells, and feathers.

23. The method of claim 21 wherein:
the thermoplastic material is selected from the group consisting of polyethylene, polypropylene and polyvinyl chloride.

24. The method of claim 21 wherein:
the step of coating the natural fiber comprises mixing the natural fiber with a liquid including the ultraviolet inhibitor or the ultraviolet blocker.

25. The method of claim 21 wherein:
the step of coating the natural fiber comprises mixing the natural fiber with an emulsion including the ultraviolet inhibitor or the ultraviolet blocker.

26. The method of claim 21 wherein:
the step of coating the natural fiber comprises mixing the natural fiber with a powder including the ultraviolet inhibitor or the ultraviolet blocker.

27. The method of claim 21 wherein:
the natural fiber is treated with a bleaching or oxidizing agent before coating the natural fiber with an ultraviolet inhibitor or an ultraviolet blocker.

28. The method of claim 27 wherein:
the bleaching or oxidizing agent is selected from the group consisting of hydrogen peroxide, inorganic peroxides, organic peroxides, inorganic persalts, and mixtures thereof.

29. The method of claim 21 wherein the natural fiber is wood flour.

30. The method of claim 21 wherein the method further comprises drying the coated natural fiber before adding the coated natural fiber to the thermoplastic material.

31. The method of claim 21 wherein the method further comprises pelletizing the coated natural fiber before adding the coated natural fiber to the thermoplastic material.

32. The method of claim 21 wherein the method further comprises pelletizing the coated natural fiber-thermoplastic material mixture before forming the coated natural fiber-thermoplastic material mixture into a composite material.

33. The method of claim 21 wherein the step of forming the mixture comprises extruding the mixture.

34. A method for making a color stabilized composite material, the method comprising:
providing a natural fiber;
mixing the natural fiber with a bleaching or oxidizing agent to provide a natural fiber mixture; and
adding the natural fiber mixture to a thermoplastic material to create a natural fiber-thermoplastic material mixture; and
forming the natural fiber-thermoplastic material mixture into a composite material.

35. The method of claim 34 wherein:
the natural fiber is selected from the group consisting of wood, hemp, flax, kenaf, peanut shells, and feathers.

36. The method of claim 34 wherein:
the thermoplastic material is selected from the group consisting of polyethylene, polypropylene and polyvinyl chloride.

37. The method of claim 34 wherein:
the bleaching or oxidizing agent is selected from the group consisting of hydrogen peroxide, inorganic peroxides, organic peroxides, inorganic persalts, and mixtures thereof.

38. The method of claim 34 wherein:
the step of forming the natural fiber-thermoplastic material mixture into the composite material comprises extruding the natural fiber-thermoplastic material mixture.

39. The method of claim 38 wherein:
the bleaching or oxidizing agent reacts with the natural fiber during extrusion.

40. The method of claim 34 wherein the natural fiber is wood flour.

41. The method of claim 40 wherein:
the bleaching or oxidizing agent is selected from the group consisting of hydrogen peroxide, inorganic peroxides, organic peroxides, and mixtures thereof.

42. A color stabilized composite building material comprising:
an elongated substrate; and
a coating disposed on a longitudinal circumference of the substrate,
wherein the coating comprises a thermoplastic material, and
wherein the coating has a thickness of 0.005″ or greater, and
wherein the substrate consists essentially of wood or the substrate comprises a wood-based composite material selected from the group consisting of plywood, laminated veneer lumber, parallel-laminated veneer, cellulosic fiberboard, particle board, waferboard, flakeboard, chipboard, and oriented strand board.

43. The composite building material of claim 42 wherein:
the coating includes an ultraviolet inhibitor or an ultraviolet blocker.

44. The composite building material of claim 42 wherein:
the coating includes a colorant.

45. The composite building material of claim 42 wherein:
the coating includes an inlay.

46. The composite building material of claim 42 wherein:
the coating comprises a powder coating.

47. The composite building material of claim 42 further comprising:
a clear protective layer over the coating.

48. The composite building material of claim 47 wherein:
the protective layer comprises a polymeric material.

49. The composite building material of claim 42 wherein:
the substrate consists essentially of wood.

50. The composite material of claim 42 wherein:
the substrate comprises a wood-based composite material selected from the group consisting of plywood, laminated veneer lumber, parallel-laminated veneer, cellulosic fiberboard, particle board, waferboard, flakeboard, chipboard, and oriented strand board.

51. The composite material of claim 42 wherein:
wherein the coating has a thickness of 0.050″ or greater.

52. The composite material of claim 42 wherein:
the coating includes an additive selected from the group consisting of anti-fungal agents, antimicrobial agents, fire retardant agents, pest control agents, and coupling agents.

53. A color stabilized composite building material comprising:
a matrix comprising a polymeric material; and
a delignified cellulosic fiber material dispersed in the matrix,
wherein the delignified cellulosic fiber material has a level of lignin such that the delignified cellulosic fiber material does not undergo a visually detectable color change when exposed to ultraviolet radiation, and
wherein the building material is essentially free of lignin.

54. The building material of claim 53 wherein:
the polymeric material is a thermoplastic material.

55. The building material of claim 54 wherein:
the thermoplastic material is selected from the group consisting of polyethylene, polypropylene and polyvinyl chloride.

56. The building material of claim 53 wherein:
the fiber material is selected from the group consisting of wood, hemp, flax, kenaf, and peanut shells.

57. The building material of claim 53 wherein:
the fiber material is wood flour.

58. The building material of claim 53 wherein:
the building material comprises 10%-95% by weight of the polymeric material and 5%-90% by weight of the delignified cellulosic fiber material.
